(19) United States
(12) Patent Application Publication
(10) Pub. No.: US 2026/0180634 A1
(43) Pub. Date: Jun. 25, 2026

(54) CSI-ERROR-AWARE MULTIUSER PRECODING

(71) Applicant: Samsung Electronics Co., Ltd., Suwon-si (KR)

(72) Inventors: Rui Huang, Vancouver (CA); R A Nadisanka Perera Rupasinghe, McKinney, TX (US); Yang Li, Plano, TX (US); Jianzhong Zhang, Dallas, TX (US)

(21) Appl. No.: 19/411,169

(22) Filed: Dec. 5, 2025

Related U.S. Application Data
(60) Provisional application No. 63/737,189, filed on Dec. 20, 2024.

(51) Int. Cl. H04B 7/0456; H04W 72/121

(52) U.S. Cl. CPC H04B 7/0456; H04W 72/121

(57) ABSTRACT

Methods and apparatuses for a CSI-aware multiuser precoding in wireless communication systems. The method of a network entity comprises: receiving, from a user equipment (UE), a precoding matrix indicator (PMI) report; identifying codebook information of the UE; identifying, based on the codebook information and PMIs that are pre-reported to the BS, prior information of a channel state information (CSI) error distribution; identifying, based on the prior information of the CSI error distribution and the PMI report, a CSI-error-aware multi-user (MU) precoder; and performing, based on the CSI-error-aware MU precoder, a beamforming operation for a massive multi-input multi-output (MIMO) operation.

### CROSS-REFERENCE TO RELATED APPLICATIONS AND CLAIM OF PRIORITY

The present application claims priority to U.S. Provisional Patent Application No. 63/737,189, filed on Dec. 20, 2024. The contents of the above-identified patent documents are incorporated herein by reference.

### TECHNICAL FIELD

The present disclosure relates generally to wireless communication systems and, more specifically, the present disclosure relates to a channel state information (CSI)-aware multiuser precoding in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a CSI-aware multiuser precoding in wireless communication systems.

In one embodiment, a base station (BS) in a wireless communication system is provided. The BS comprises a transceiver configured to receive, from a user equipment (UE), a precoding matrix indicator (PMI) report. The BS further includes a processor operably coupled to the transceiver, the processor configured to: identify codebook information of the UE, identify, based on the codebook information and PMIs that are pre-reported to the BS, prior information of a CSI error distribution, identify, based on the prior information of the CSI error distribution and the PMI report, a CSI-error-aware multi-user (MU) precoder, and perform, based on the CSI-error-aware MU precoder, a beamforming operation for a massive multi-input multi-output (MIMO) operation.

In another embodiment, a method of a BS in a wireless communication system is provided. The method comprises: receiving, from a UE, a PMI report; identifying codebook information of the UE; identifying, based on the codebook information and PMIs that are pre-reported to the BS, prior information of a CSI error distribution; identifying, based on the prior information of the CSI error distribution and the PMI report, a CSI-error-aware MU precoder; and performing, based on the CSI-error-aware MU precoder, a beamforming operation for a massive MIMO operation.

In yet another embodiment, a UE in a wireless communication system is provided. The UE comprises a processor and a transceiver operably coupled to the processor, the transceiver configured to transmit, to a BS, a PMI report, wherein: codebook information of the UE is identified, based on the codebook information and PMIs that are pre-reported to the BS, prior information of a CSI error distribution is identified, based on the prior information of the CSI error distribution and the PMI report, a CSI-error-aware MU precoder is identified, and based on the CSI-error-aware MU precoder, a beamforming operation for a massive MIMO operation is performed.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of a mMIMO BS for PMI-based precoding according to various embodiments of the present disclosure;

FIG. 8 illustrates a flowchart of a method for a CSI-error-aware precoding according to various embodiments of the present disclosure;

FIG. 9 illustrates examples of CDF according to various embodiments of the present disclosure; and

FIG. 10 illustrates a flowchart of a method for a CSI-aware multiuser according to various embodiments of the present disclosure.

### DETAILED DESCRIPTION

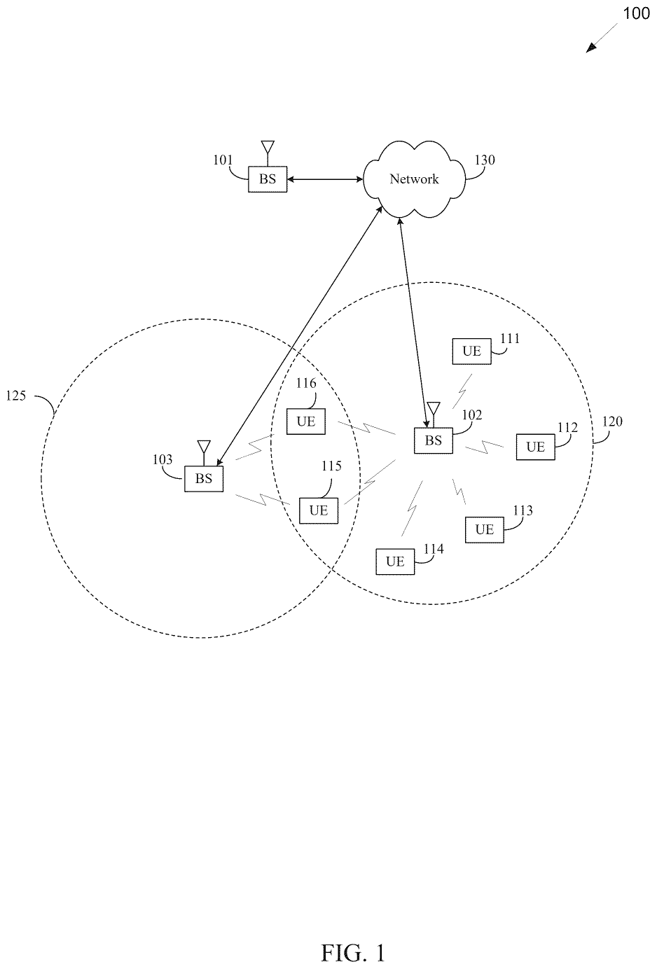

FIG. 1 through FIG. 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 36.211 v16.4.0, “E-UTRA, Physical channels and modulation”; 3GPP TS 36.212 v16.4.0, “E-UTRA, Multiplexing and Channel coding”; 3GPP TS 36.213 v16.4.0, “E-UTRA, Physical Layer Procedures”; 3GPP TS 36.321 v16.3.0, “E-UTRA, Medium Access Control (MAC) protocol specification”; 3GPP TS 36.331 v16.3.0, “E-UTRA, Radio Resource Control (RRC) Protocol Specification”; 3GPP TS 38.211 v16.4.0, “NR, Physical channels and modulation”; 3GPP TS 38.212 v16.4.0, “NR, Multiplexing and Channel coding”; 3GPP TS 38.213 v16.4.0, “NR, Physical Layer Procedures for Control”; 3GPP TS 38.214 v16.4.0, “NR, Physical Layer Procedures for Data”; 3GPP TS 38.215 v16.4.0, “NR, Physical Layer Measurements”; 3GPP TS 38.321 v16.3.0, “NR, Medium Access Control (MAC) protocol specification”; and 3GPP TS 38.331 v16.3.1, “NR, Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to generate signals and/or information supporting a CSI-aware multiuser precoding, at a gNB 101-103, in wireless communication systems. In certain embodiments, and one or more of the gNBs 101-103 includes circuitry, programing, or a combination thereof, to support a CSI-aware multiuser precoding in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

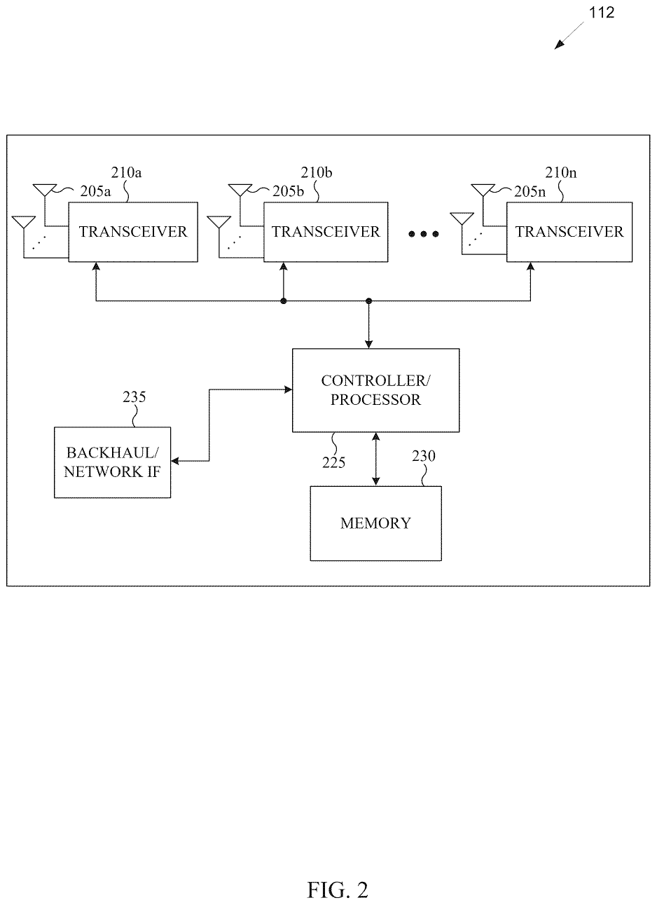

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support a CSI-aware multiuser precoding in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

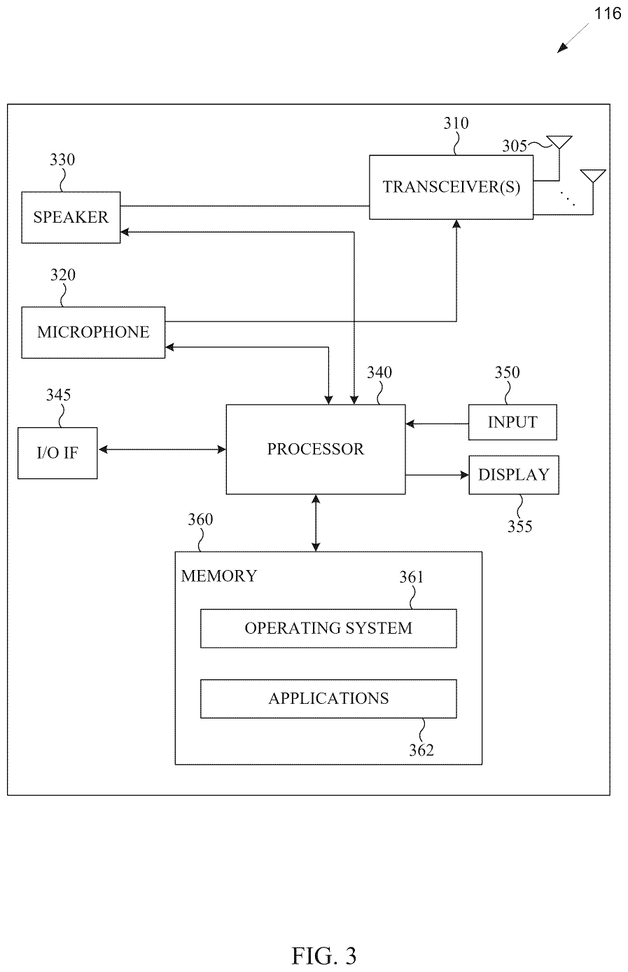

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate signals and/or information for supporting a CSI-aware multiuser precoding, at the gNB 101-103, in wireless communication systems.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

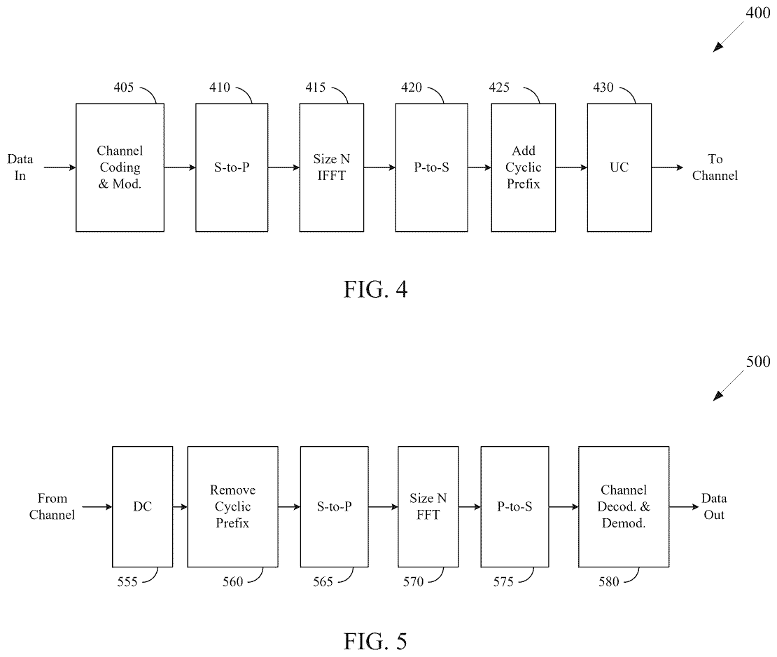

FIG. 4 and FIG. 5 illustrate examples of wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more multiple types of RS including reference signal (RS) CSI-RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest MCS for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

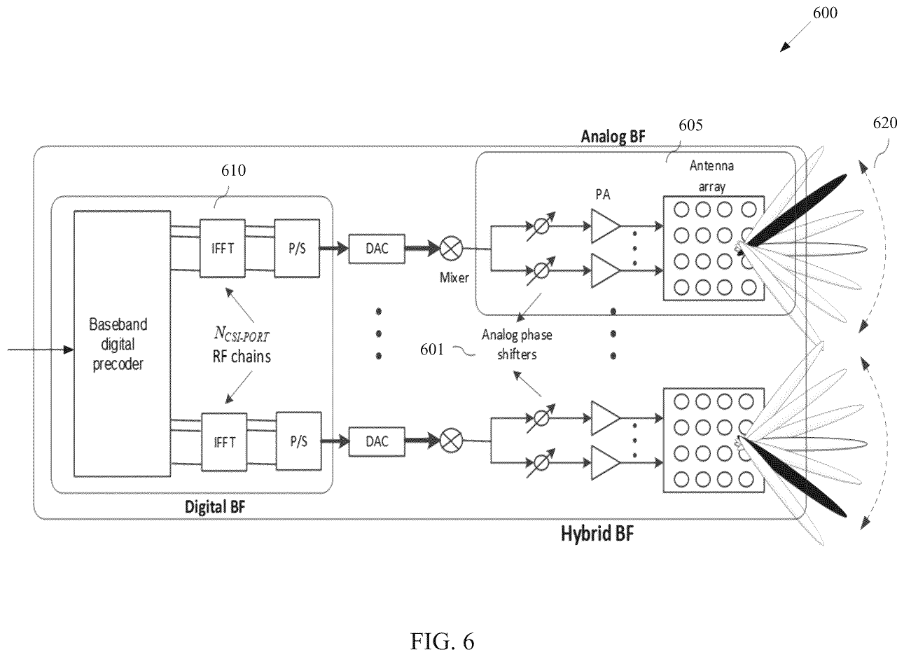

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss at 100 m distance), larger number of and sharper analog beams (hence larger number of radiators in the array) may compensate for the additional path loss.

For a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size for a carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) cannot be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

The present disclosure provides a new PMI-based precoding framework for massive MIMO (mMIMO) and provides methods to perform signal processing for the RF receive/transmit antenna network of multiple RRHs/panels in the system to support simultaneous transmission from multiple TRPs to multiple UEs, where the provided methods can be realized based on a link adaptation, a precoding, a multi-antenna processing, a codebook, and a feedback design for the purposes of interference cancellation and throughput enhancement.

Embodiments relate to electronic devices and methods on precoding and beamforming methods for (massive) MIMO operations, more particularly, to electronic devices and methods for multiuser precoding, interference management, and throughput enhancement in (massive) MIMO of wireless networks.

A precoder design is an important issue for multiuser massive MIMO for enhancing the received signal power and mitigate the interference, especially when multiple UEs scheduled to share the same time, frequency, and power resources. Specifically, for a link adaptation, a proper rank may be determined based on the DL channels between the base station (BS) and the scheduled UEs.

The design for precoding for each of the scheduled users utilizes explicit (e.g., SRS) or implicit signaling (e.g., PMI) to obtain the information about the UL/DL CSI between the antenna ports of transmitters and receivers. With such information about the UL/DL channels, the precoder for each UE can be properly derived to potentially maximize the SINR of the received signal, thereby achieving a higher throughput.

When a UE reports a PMI, the UE measures the DL channel and finds the optimal PMI within the codebook. Due to the utilization of various types of codebooks (e.g., Type I and/or Type II codebook), the PMIs reported by the UEs introduce quantization error to the reported CSI at the BS. Given such PMI quantization error, the precoders derived at the BS performs an operation to take the quantization error into account, in order to achieve the optimal performance.

In the present disclosure, multiuser massive MIMO systems with PMI-based DL transmissions are investigated, and a new CSI-error-aware precoding are provided to tackle the quantization error and improve the systems throughput.

In the present disclosure, the CSI-error-aware multiuser precoding is provided for massive MIMO systems, where implicit signaling (e.g., PMI) are used to obtain the CSI. The provided methods exploit the statistic of quantization error of the CSI obtained from implicit signals, to improve the multiuser precoding designs. By taking the quantization error into account, the CSI-error-aware precoding is capable of achieving higher throughput than the baseline, where the impact of such quantization error was ignored. The present disclosure also includes extensive performance evaluation results to demonstrate the effectiveness of the provided methods on improving the throughput of the multiuser massive MIMO systems.

In the present disclosure, a CSI-error-aware multiuser precoding is provided for a massive MIMO system based on using implicit signaling (e.g., PMI) to obtain CSI and prior knowledge of CSI error distribution.

In the present disclosure, the usage of statistics of quantization error of the CSI obtained from the implicit signals and the codebook designs is provided to derive the CSI-error-aware multiuser precoding.

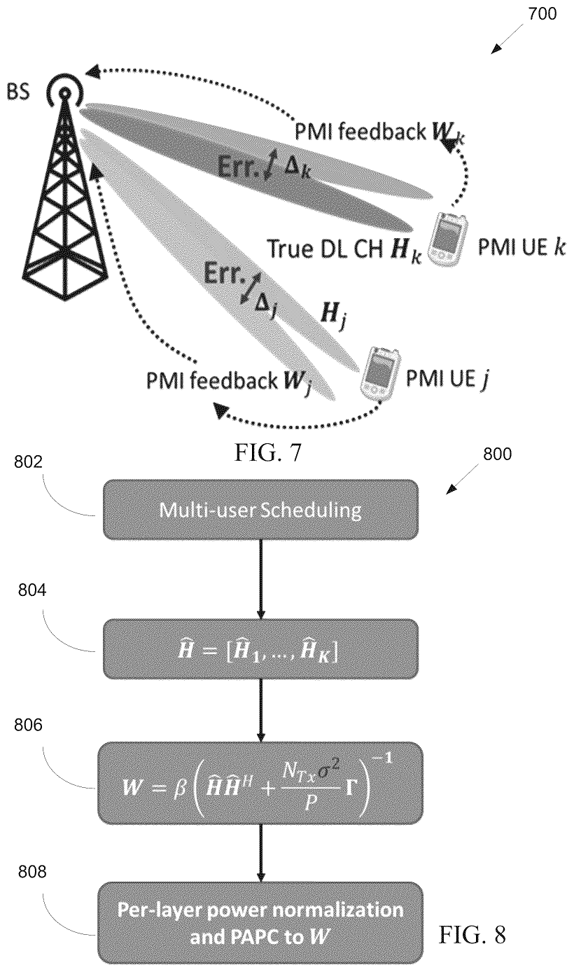

FIG. 7 illustrates an example of a mMIMO BS for PMI-based precoding 700 according to various embodiments of the present disclosure. An embodiment of the mMIMO BS for PMI-based precoding 700 shown in FIG. 7 is for illustration only.

In the present discloses, a new PMI-based precoding framework is provided for mMIMO. As illustrated in FIG. 7, an example of a mMIMO BS for PMI-based precoding comprises one or more transceiver configured to receive, from one or more UEs, a PMI from a PUSCH. A BS comprises N_{Tx} Tx ports and there are N_{RB} number of resource blocks for DL data transmission.

For a mMIMO systems with K>1 UEs, let the DL channel between BS and UE k be Hₖ, k=1, . . . , K. Upon receiving CSI-RS, a UE k determines the PMI and feedback to the BS. Let Wₖ denote the PMI feedback from the UE k.

When a UE reports a PMI, the UE measures the DL channel and find the optimal PMI within the codebook. Due to the codebook design (e.g., Type I and/or Type II codebook), PMIs reported by the UEs introduce quantization error. Let Δₖ denotes the quantization error between derived PMI and UE k's channel. In particular, the relationship between the reported PMIs, the true DL channel, and the quantization error can be established as: Hₖ=Ĥₖ=Δₖ, where

$${\hat{H}}_{k} = {W}_{k}^{H} \cdot {\hat{H}}_{k} = {W}_{k}^{H}$$

is referred to as the reported PMI channel for the easy of presentation. Let Ĥ=[Ĥ₁, . . . , Ĥ_{K}], and H=[H₁, . . . , H_{K}].

Given such PMI quantization error, the precoders derived at BS based on Ĥₖ, k=1, . . . , K, may perform an operation take the quantization error into account, in order to achieve the optimal performance.

In one embodiment, a new CSI-error-aware precoding method is provided to maximize the multi-user sum-rate, by taking the PMI quantization error into account.

This problem can be formulated as determining optimal precoders W=[W₁, . . . , W_{K}] for multi-user (MU) transmission:

$${max}_{W} {𝔼}_{H \vert \hat{H}} \{ {\sum }_{k} {log}_{2} \vert I + S I N {R}_{k} ( W ) \vert \} s . t . tr ( {WW}^{H} ) \leq ρ , \qquad ( P1 )$$

where SINRₖ(W) is the achievable signal-to-interference-plus-noise ratio (SINR) of UE k, which is given by:

$$S I N {R}_{k} ( W ) = {H}_{k}^{H} {W}_{k} {W}_{k}^{H} {H}_{k} {( {\sum }_{j \neq k} {H}_{k}^{H} {W}_{j} {W}_{j}^{H} {H}_{k} + {σ}_{n}^{2} I )}^{- 1} .$$

In one embodiment, a CSI-error-aware precoding, which is derived as the solution to (P1), is given by:

$$W = β {( \hat{H} {\hat{H}}^{H} + \frac{{N}_{Tx} {σ}^{2}}{P} Γ )}^{- 1} \hat{H} \qquad ( 1 )$$

In equation (1), β is a scaler to ensure the transmit power constraint tr(WW^{H})≤ρ can be satisfied. Γ=diag(γ₁, . . . , γₖ) is a diagonal matrix, in which each element γₖ is determined by the statistics of quant. error Δₖ of user k.

In one embodiment, γₖ is common for all UEs since they have the same statistics of quantization error. In this case, only a common γ is used since γ₁=γ₂= . . . =γ_{K}=γ.

In another embodiment, the value of γₖ is chosen from a predefined set γ including all possible values. As an example, γ={0, 1e⁻³, 1e⁻², 5e⁻², 1e⁻¹, 5e⁻¹, 1, 1e²}. These values are chosen to cover different scales/magnitudes of γ.

In one embodiment, the optimal value of γₖ can be identified as the one from the set γ that leads to the maximum average data rate.

FIG. 8 illustrates a flowchart of a method 800 for a CSI-error-aware precoding according to various embodiments of the present disclosure. The method 800 may be performed by a network entity (e.g., base station, 101-103 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the method 800 begins at step 802. In step 802, a BS determines the multi-user scheduling and schedule the K UEs for DL transmission. In step 804, the scheduled K UEs send the PMI feedbacks to the BS. The BS receives the PMI feedbacks and obtain the reported PMI channels of all K UEs as Ĥ=[Ĥ₁, . . . , Ĥ_{K}]. In step 806, the BS derives the CSI-error-aware precoders W using equation (1). In step 808, the BS performs per-layer power normalization and per-antenna power control (PAPC) to the derived W, and then proceed with DL transmissions to the scheduled K UEs.

The performance of the provided CSI-error-aware precoders is compared with the baseline, which is the multi-user (MU) PMI DL transmission using Type I codebook. The results are as follows.

In TABLE 1, the average MU sum-rate between the provided CSI-error-aware precoders and the baseline is compared. The results showed that the provided method achieves 8% higher MU sum-rate than the baseline.

TABLE 1
Average MU sum rate

| | Baseline MU PMI | CSI-Error-Aware Precoding |
|---|---|---|
| Average MU | 77.1 Mbps (100%) | 83.3 Mbps (108%) |
| Sum Rate | | |

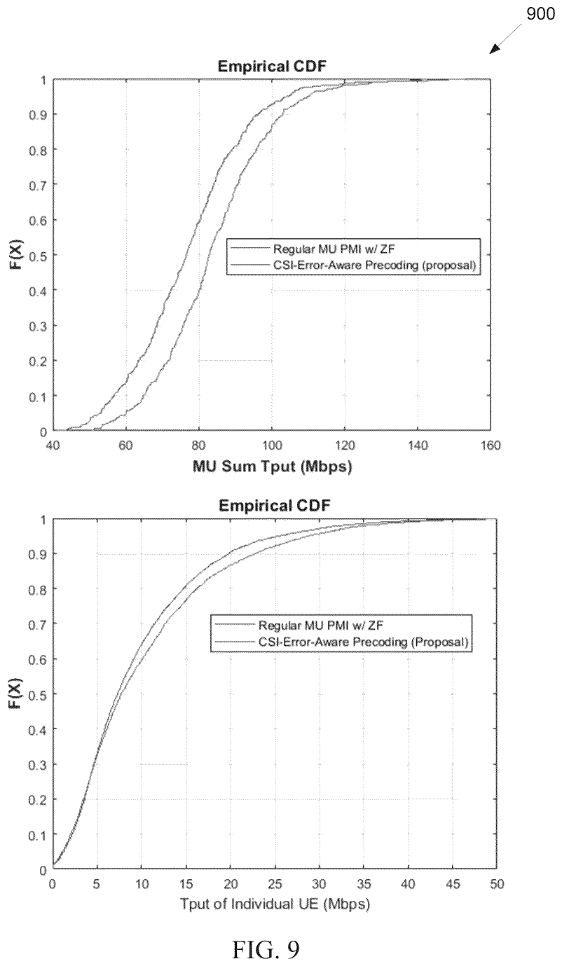

FIG. 9 illustrates examples of CDF 900 according to various embodiments of the present disclosure. An embodiment of the CDF 900 shown in FIG. 9 is for illustration only.

In FIG. 9, the empirical distribution function (CDF) between the provided CSI-error-aware precoders and the baseline is compared. The results demonstrated that the provided CSI-error-aware precoders outperform the baseline, in terms of MU sum-rate and the data rate of individual UE.

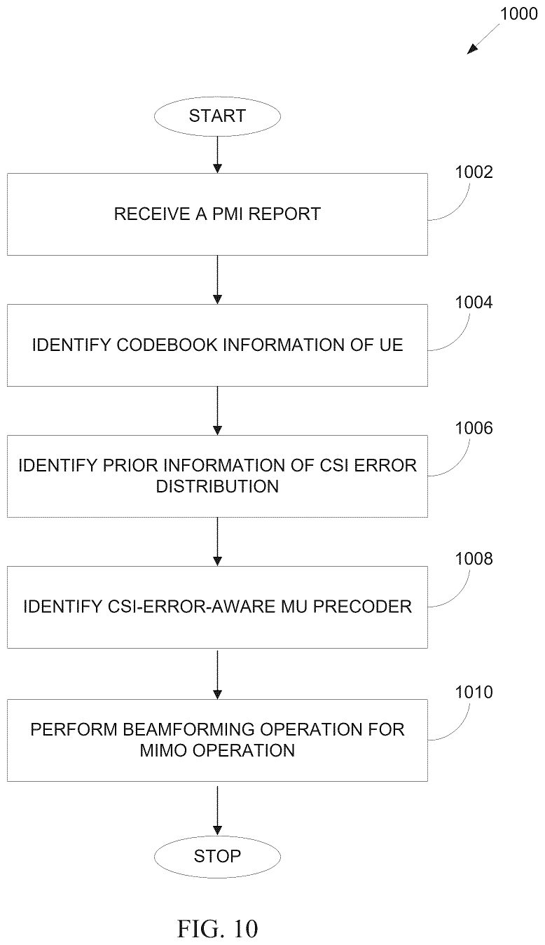

FIG. 10 illustrates a flowchart of a method 1000 for a CSI-aware multiuser according to various embodiments of the present disclosure. The method 1000 may be performed by a network entity (e.g., base station, 101-103 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, the method 1000 begins at step 1002. In step 1002, a BS receives, from a UE, a PMI report. Subsequently, In step 1004, the BS identifies codebook information of the UE. Subsequently, the BS in step 1006, identifies, based on the codebook information and PMIs that are pre-reported to the BS, prior information of a CSI error distribution. Next, in step 1008, the BS identifies, based on the prior information of the CSI error distribution and the PMI report, a CSI-error-aware MU precoder. Finally, in step 1010, the BS performs, based on the CSI-error-aware MU precoder, a beamforming operation for a massive MIMO operation.

In one embodiment, the BS receives, from the UE, information for statistics of a quantization error of CSI. In such embodiment, the codebook information includes a type of the codebook that is currently being used in the UE and reported to the BS, or the codebook information is configured by the BS.

In one embodiment, the BS identifies a value of a diagonal matrix including elements determined by the statistics of the quantization error of the CSI.

In one embodiment, the BS identifies, based on the information and the type of the codebook, the CSI-error-aware MU precoder.

In such embodiments, the quantization error is identified based on the reported PMI and a channel status between the UE and the BS.

In one embodiment, the BS performs, based on the CSI-error-aware MU precoder, a per-layer power normalization operation and a PAPC operation.

In one embodiment, the BS schedules a plurality of UEs including the UE for performing a multi-user scheduling.

In one embodiment, the BS receives, from each of the plurality of UEs, the PMI report.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the claims appended. None of the description in this application should be read as implying that any particular element, step, or function is an essential element that must be included in the claims scope. The scope of patented subject matter is defined by the claims.

What is claimed is:

1. A base station (BS) in a wireless communication system, the BS comprising:
a transceiver configured to receive, from a user equipment (UE), a precoding matrix indicator (PMI) report; and
a processor operably coupled to the transceiver, the processor configured to:
identify codebook information of the UE,
identify, based on the codebook information and PMIs that are pre-reported to the BS, prior information of a channel state information (CSI) error distribution,
identify, based on the prior information of the CSI error distribution and the PMI report, a CSI-error-aware multi-user (MU) precoder, and
perform, based on the CSI-error-aware MU precoder, a beamforming operation for a massive multi-input multi-output (MIMO) operation.

2. The BS of claim 1, wherein the transceiver is further configured to receive, from the UE, information for statistics of a quantization error of CSI, and
wherein:
the codebook information includes a type of a codebook that is currently being used in the UE and reported to the BS, or
the codebook information is configured by the BS.

3. The BS of claim 2, wherein the processor is further configured to identify a value of a diagonal matrix including elements determined by the statistics of the quantization error of the CSI.

4. The BS of claim 2, wherein the processor is further configured to identify, based on the information and the type of the codebook, the CSI-error-aware MU precoder.

5. The BS of claim 2, wherein the quantization error is identified based on the reported PMI and a channel status between the UE and the BS.

6. The BS of claim 1, wherein the processor is further configured to perform, based on the CSI-error-aware MU precoder, a per-layer power normalization operation and a per-antenna power control (PAPC) operation.

7. The BS of claim 1, wherein:
the processor is further configured to schedule a plurality of UEs including the UE for performing a multi-user scheduling; and
the transceiver is further configured to receive, from each of the plurality of UEs, the PMI report.

8. A method of a base station (BS) in a wireless communication system, the method comprising:
receiving, from a user equipment (UE), a precoding matrix indicator (PMI) report;
identifying codebook information of the UE;
identifying, based on the codebook information and PMIs that are pre-reported to the BS, prior information of a channel state information (CSI) error distribution;
identifying, based on the prior information of the CSI error distribution and the PMI report, a CSI-error-aware multi-user (MU) precoder; and
performing, based on the CSI-error-aware MU precoder, a beamforming operation for a massive multi-input multi-output (MIMO) operation.

9. The method of claim 8, further comprising receiving, from the UE, information for statistics of a quantization error of CSI, wherein:
the codebook information includes a type of a codebook that is currently being used in the UE and reported to the BS, or
the codebook information is configured by the BS.

10. The method of claim 9, further comprising identifying a value of a diagonal matrix including elements determined by the statistics of the quantization error of the CSI.

11. The method of claim 9, further comprising identifying, based on the information and the type of the codebook, the CSI-error-aware MU precoder.

12. The method of claim 9, wherein the quantization error is identified based on the reported PMI and a channel status between the UE and the BS.

13. The method of claim 8, further comprising performing, based on the CSI-error-aware MU precoder, a per-layer power normalization operation and a per-antenna power control (PAPC) operation.

14. The method of claim 8, further comprising:
scheduling a plurality of UEs including the UE for performing a multi-user scheduling; and
receiving, from each of the plurality of UEs, the PMI report.

15. A user equipment (UE) in a wireless communication system, the UE comprising:
a processor; and
a transceiver operably coupled to the processor, the transceiver configured to transmit, to a base station (BS), a precoding matrix indicator (PMI) report,
wherein:
codebook information of the UE is identified,
based on the codebook information and PMIs that are pre-reported to the BS, prior information of a channel state information (CSI) error distribution is identified,
based on the prior information of the CSI error distribution and the PMI report, a CSI-error-aware multi-user (MU) precoder is identified, and
based on the CSI-error-aware MU precoder, a beamforming operation for a massive multi-input multi-output (MIMO) operation is performed.

16. The UE of claim 15, wherein the transceiver is further configured to transmit, to the BS, information for statistics of a quantization error of CSI, and
wherein:
the codebook information includes a type of a codebook that is currently being used in the UE and reported to the BS, or
the codebook information is configured by the BS.

17. The UE of claim 16, wherein a value of a diagonal matrix including elements determined by the statistics of the quantization error of the CSI is identified; and
wherein, based on the information and the type of the codebook, the CSI-error-aware MU precoder is identified.

18. The UE of claim 16, wherein the quantization error is identified based on the reported PMI and a channel status between the UE and the BS.

19. The UE of claim 16, wherein, based on the CSI-error-aware MU precoder, a per-layer power normalization operation and a per-antenna power control (PAPC) operation is identified.

20. The UE of claim 16, wherein:
a plurality of UEs including the UE for performing a multi-user scheduling is scheduled; and
each of the plurality of UEs is configured to transmit, to the BS, the PMI report.
